(19) United States
(12) Patent Application Publication
(10) Pub. No.: US 2025/0271556 A1
(43) Pub. Date: Aug. 28, 2025

(54) OBJECT DETECTION DEVICE AND OBJECT DETECTION METHOD

(71) Applicant: DENSO CORPORATION, Kariya-city (JP)

(72) Inventors: Ryo YAMAMOTO, Kariya-city (JP); Keiko AKIYAMA, Kariya-city (JP)

(21) Appl. No.: 19/205,382

(22) Filed: May 12, 2025

Related U.S. Application Data
(63) Continuation of application No. PCT/JP2023/039542, filed on Nov. 2, 2023.

(30) Foreign Application Priority Data
Nov. 15, 2022 (JP) 2022-182746

(51) Int. Cl. G01S 7/487; G01S 7/481; G01S 7/484; G01S 7/4863; G01S 7/4865; G01S 17/04; G01S 17/931

(52) U.S. Cl. CPC G01S 7/4873; G01S 7/4817; G01S 7/484; G01S 7/4863; G01S 7/4865; G01S 7/4876; G01S 17/04; G01S 17/931

(57) ABSTRACT

An object detection device or an object detection method for detecting an object irradiates, with light, a measurement area using a sensor, detects reflection light from an object in the measurement area using the sensor, detecting a plurality of signal waveforms of the reflection light, wherein the plurality of waveforms reach the sensor with a time difference, and determines whether the object indicated by the plurality of signal waveforms is a virtual object based on a magnitude relationship of a plurality of waveform widths of the plurality of signal waveforms.

### CROSS REFERENCE TO RELATED APPLICATIONS

The present application is a continuation application of International Patent Application No. PCT/JP2023/039542 filed on Nov. 2, 2023, which designated the U.S. and claims the benefit of priority from Japanese Patent Application No. 2022-182746 filed on Nov. 15, 2022. The entire disclosures of all of the above applications are incorporated herein by reference.

### TECHNICAL FIELD

The present disclosure relates to a technology for detecting an object.

### BACKGROUND

As a comparative example, a signal waveform of the reflection light from a sensor that detects the reflection light of an object is acquired, and multiple signal waveforms that reach the sensor with a time difference are acquired. Then, by comparing the magnitude relationship of the peak intensities of the multiple signal waveforms, it is determined whether the object indicated by the signal waveform is a virtual object.

### SUMMARY

According to an aspect of the present disclosure, an object detection device or an object detection method for detecting an object irradiates, with light, a measurement area using a sensor, detects reflection light from an object in the measurement area using the sensor, detecting a plurality of signal waveforms of the reflection light, wherein the plurality of waveforms reach the sensor with a time difference, and determines whether the object indicated by the plurality of signal waveforms is a virtual object based on a magnitude relationship of a plurality of waveform widths of the plurality of signal waveforms.

### BRIEF DESCRIPTION OF DRAWINGS

FIG. 1 is a diagram showing a schematic configuration of a LIDAR module.

FIG. 2 is a schematic diagram illustrating a mechanical configuration and a measurement area of the LiDAR.

FIG. 3 is a diagram showing a light reception element.

FIG. 4 is a diagram showing a functional configuration of a processing unit.

FIG. 5 is a diagram illustrating an assumed measurement situation.

FIG. 6 is a graph illustrating an amplitude of a signal waveform corresponding to a reflector.

FIG. 7 is a graph illustrating the amplitude of the signal waveform corresponding to raindrops.

FIG. 8 is a graph illustrating the magnitude relationship of the amplitudes.

FIG. 9 is a graph illustrating the magnitude relationship of the amplitudes.

FIG. 10 is a graph illustrating a peak intensity of the signal waveform corresponding to the reflector.

FIG. 11 is a graph illustrating the peak intensity of the signal waveform corresponding to raindrops.

FIG. 12 is a flowchart showing an example of an object detection process.

FIG. 13 is a diagram showing a functional configuration of the processing unit.

FIG. 14 is a diagram illustrating a relationship between ROI and intensity saturation.

FIG. 15 is a diagram illustrating a relationship between the ROI and intensity saturation.

FIG. 16 is a diagram showing a functional configuration of the processing unit.

FIG. 17 is a diagram illustrating detection of a road surface using a disturbance light image.

FIG. 18 is a diagram illustrating overlap of a reflector distance and a signal waveform.

### DETAILED DESCRIPTION

In the comparative example, when the peak intensity in the signal waveform becomes saturated, it becomes impossible to compare the magnitude relationship itself. In other words, the comparative example is not sufficiently versatile to be used for determining virtual objects.

An example of the present disclosure provides an object detection device and an object detection method that improve the versatility of virtual object determination.

According to one example embodiment, an object detection device is configured to detect an object based on information acquired from a sensor that irradiates, with irradiation light, a measurement area and detects reflection light from the object in the measurement area, and the device includes: a waveform detection unit configured to detect a plurality of signal waveforms of the reflection light, wherein the plurality of waveforms reach the sensor with a time difference; and a virtual object determination unit configured to determine whether the object indicated by the plurality of signal waveforms is a virtual object based on a magnitude relationship of a plurality of waveform widths of the plurality of signal waveforms.

According to another example of the present disclosure, an object detection method is executed by at least one processor for detecting an object, and the method includes: irradiating light toward a measurement area using a sensor; detecting reflection light from an object in the measurement area using the sensor; detecting a plurality of signal waveforms of the reflection light, wherein the plurality of waveforms reach the sensor with a time difference; and determining whether the object indicated by the signal waveforms is a virtual object based on the relative magnitudes of the amplitudes of the multiple signal waveforms.

According to one example embodiment, whether the object indicated by the signal waveforms is the virtual object is determined based on the relative magnitude of the amplitudes of the signal waveforms. Therefore, the determination remains effective even in cases where, for example, the peak strength of the signal waveforms becomes saturated. Therefore, it is possible to improve the versatility of determining the virtual object.

Hereinafter, multiple embodiments will be described with reference to the drawings. It is noted that the same reference numerals are attached to the corresponding constituent elements in each embodiment, and redundant description may be omitted. In each of the embodiments, when only a part of the configuration is described, the remaining parts of the configuration may adopt corresponding parts of other embodiments. Further, not only the combinations of the configurations explicitly shown in the description of the respective embodiments, but also the configurations of the plurality of embodiments can be partially combined even when they are not explicitly shown as long as there is no difficulty in the combination in particular.

### First Embodiment

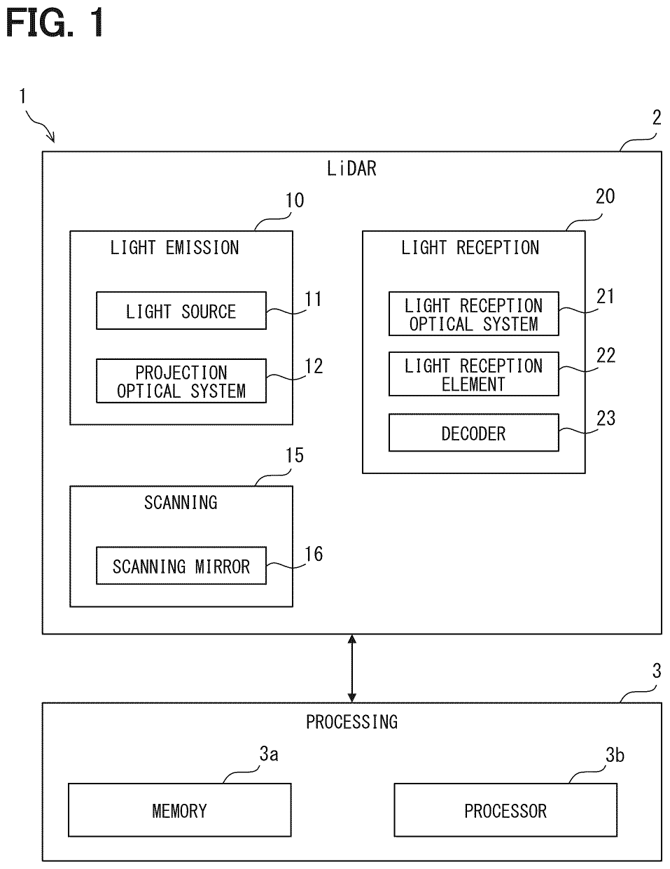

As shown in FIG. 1, a LiDAR module 1 according to a first embodiment of the present disclosure is mounted on a vehicle as a mobile body. The LiDAR module 1 detects objects in the periphery of the vehicle. The LiDAR module 1 includes a main unit of a LiDAR (Light Detection and Ranging/Laser Imaging Detection and Ranging) 2 and a processing unit 3. In the present embodiment, the main unit of the LiDAR 2 and the processing unit 3 are, for example, housed in a common case and integrated together. The processing unit 3 is a dedicated processing device dedicated for controlling the main unit of the LiDAR 2 or for object detection.

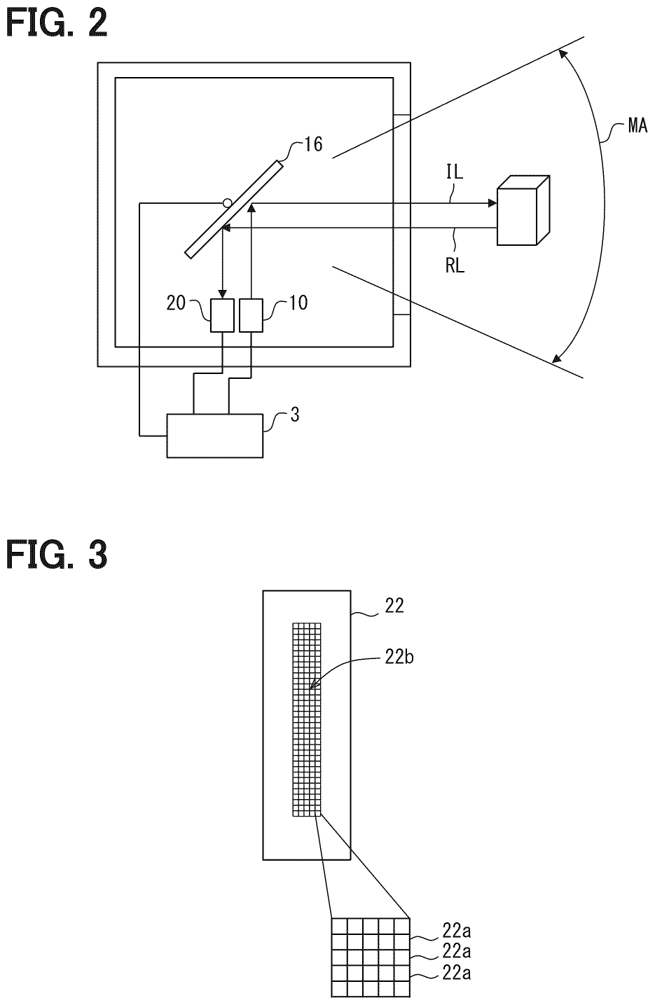

The LiDAR 2 is an in-vehicle sensor and an optical distance measurement device that irradiates a measurement area MA with irradiation light IL from a light source 11 and detects the reflection light RL from an object. The LiDAR 2 is, for example, placed on the front grille, roof, or other parts of the vehicle. As shown in FIG. 2, the LiDAR 2 includes a light emission unit 10, a scanning unit 15, and a light reception unit 20.

The light emission unit 10 emits the irradiation light IL towards a measurement area MA. The light emission unit 10 includes, for example, a light source 11 and a light projection optical system 12. The light source 11 may be a single light source or multiple light sources. The light source 11 may be, for example, a laser oscillation element such as a laser diode (LD). The light source 11 may also be an LED. The wavelength of the light emitted by the light source 11 may be a wavelength other than visible light, such as near-infrared light. The light projection optical system 12 condenses the light emitted from the light source 11 and projects it as a beam of light toward the measurement area MA. The light projection optical system 12 includes one or more lenses.

The scanning unit 15 scans the light emitted from the light emission unit 10 within the range of the measurement area MA. The scanning unit 15 includes a scanning mirror 16. The scanning mirror 16 includes a drive motor and a reflector. The drive motor may be, for example, a voice coil motor, a brushed DC motor, a stepping motor, or the like. The drive motor drives a rotational axis of the reflector in synchronization with the light emission timing. The reflector is a mirror with a reflective surface that reflects the irradiation light IL toward the measurement area MA. The reflective surface is formed, for example, in a planar shape.

In the present embodiment, in particular, the reflector faces both the light projection optical system 12 of the light emission unit 10 and a light reception optical system 21 of the light reception unit 20. Therefore, the reflector is capable of simultaneously reflecting not only the irradiation light IL but also the reflection light RL, which is the light reflected from the object in the measurement area MA, and directing it toward the light reception unit 20.

The light reception unit 20 receives the reflection light RL. The light reception unit 20 includes the light reception optical system 21, a light reception element 22, and a decoder 23. The light reception optical system 21 focuses the reflection light RL and directs it onto the light reception element 22. The light reception optical system 21 includes one or more lenses.

The light reception element 22 receives the reflection light RL that is focused by the light reception optical system 21. The light reception element 22 may be, for example, a Single Photon Avalanche Diode (SPAD) sensor. As shown in FIG. 3, the light reception element 22 is formed as a two-dimensional array with multiple SPADs (hereinafter referred to as sensor pixels 22a) highly integrated on a detection surface 22b.

Each sensor pixel 22a generates a single electric pulse upon receiving a single photon through an electron multiplication process by avalanche multiplication (so-called Geiger mode). In other words, the sensor pixel 22a can generate an electric pulse as a digital signal directly, without passing through an analog-to-digital (AD) conversion circuit. Therefore, the light reception results can be read out at high speed.

The decoder 23 is provided to output electric pulses generated by the sensor pixels 22a and includes a selection circuit and a clock oscillator. The selection circuit sequentially selects the sensor pixels 22a from which the electric pulses are to be extracted. The selected sensor pixel 22a outputs the electric pulse to the processing unit 3. When the selection circuit has finished selecting each sensor pixel 22a once, one sampling cycle is completed. This sampling period corresponds to the clock frequency output from the clock circuit.

In addition, at the timing when no irradiation light IL is emitted from the light emission unit 10, that is, during non-emission, the light reception unit 20 is capable of detecting and receiving disturbance light from the direction corresponding to the angle of the reflector. Furthermore, by focusing the disturbance light onto the light reception element 22, it is also possible to detect objects in the measurement area MA. The disturbance light referred to here is also called background light.

The processing unit 3 processes information obtained from the main unit of the LiDAR 2 and detects the object in the measurement area MA. The processing unit 3 may be implemented, for example, by a dedicated computer. The processing unit 3 may include at least one memory 3a and at least one processor 3b. The memory 3a may be a non-transitory tangible storage medium that non-temporarily stores programs and data readable by the processor 3b, such as at least one type of semiconductor memory, magnetic media, or optical media. Furthermore, the memory 3a may also be a rewritable volatile storage medium, such as RAM (Random Access Memory).

The processor 3b includes at least one type of core, such as a CPU (Central Processing Unit), GPU (Graphics Processing Unit), or RISC (Reduced Instruction Set Computer) CPU. Additionally, the processing unit 3 may further include circuits such as an FPGA (Field-Programmable Gate Array) or an ASIC (Application Specific Integrated Circuit).

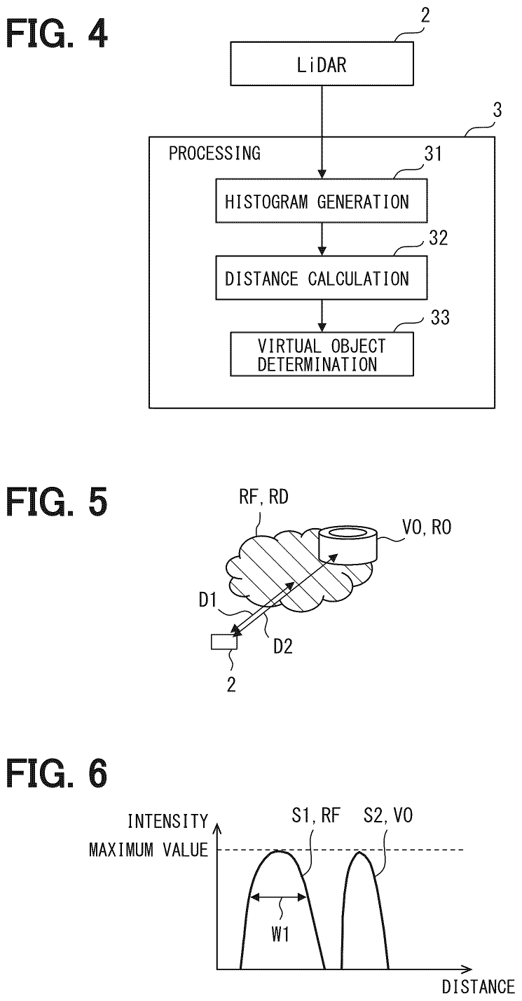

As shown in FIG. 4, the processing unit 3 includes a histogram generation unit 31, a distance calculation unit 32, and a virtual object determination unit 33, which are implemented as functional blocks by executing a program on at least one processor 3b.

The histogram generation unit 31 adds the electrical pulses corresponding to the reflection light RL output from the light reception unit 20. The histogram generation unit 31 generates a histogram of the reflection light intensity over time based on the addition results. The generated histogram substantially represents the signal waveform of the reflection light RL.

The histogram generation unit 31 typically generates a histogram for the pixels of the sensor pixel 22a within a region-of-interest (ROI) by accumulating multiple samples. By accumulating multiple samples, it is possible to improve the S/N ratio.

Additionally, each sensor pixel 22a outputs a signal that is essentially either 0 or 1 for each sampling. The number of pixels outputting 1 among the sensor pixels 22a in the ROI is considered to correspond to the intensity of the reflection light. Therefore, when all the sensor pixels 22a in the ROI output 1, the intensity of the reflection light indicates the maximum measurable value and becomes saturated. This saturation phenomenon often occurs when an object is located at a short distance or when the object is a reflector RF (also referred to as a strong reflective object).

The distance calculation unit 32 calculates a distance at which an object is located based on the histogram generated by the histogram generation unit 31, that is, the signal waveform of the reflection light RL. The time axis corresponds to a time from reflection, by the object, of the irradiation light IL from the light emission unit 10 to return to the light reception unit 20, and is commonly referred to as TOF (Time Of Flight), and this time is proportional to the distance. In other words, the distance calculation unit 32 calculates the time indicating the peak intensity of the signal waveform and calculates the distance to the object based on the time corresponding to this peak intensity PI.

For a single emission, multiple signal waveforms may sometimes reach the light reception unit 20 with a time delay. In other words, there may be multiple locations indicating the peak intensity PI in the histogram. In such cases, the distance calculation unit 32 may determine that multiple objects exist at different distances.

The virtual object determination unit 33 determines whether objects are present at each of the distances calculated by the distance calculation unit 32. The virtual object determination unit 33 determines whether the signal waveform acquired from the LiDAR 2 indicates a virtual object VO based on whether the signal waveform satisfies a predetermined condition.

As shown in FIG. 5, the virtual object VO may be, for example, a ghost or virtual image caused by multiple reflections of light between the LiDAR 2 and the reflector RF positioned at distance D1. In this case, as shown in FIG. 6, there is a tendency for a second signal waveform S2, and furthermore a third signal waveform, to be generated with a time lag relative to the first signal waveform S1 indicating the reflector RF. The second signal waveform S2 and the third signal waveform correspond to the virtual object VO, which should not originally exist at the position of distance D2.

The signal waveform corresponding to the virtual object VO should be distinguished from the signal waveform of a real object. For example, as shown in FIG. 5, in rainy weather, when a normal object RO is located at the distance D2 behind a raindrop RD positioned at distance D1, a signal waveform similar to the virtual object VO may be measured. It is necessary to avoid the object RO behind the raindrop RD being mistakenly identified as the virtual object VO.

Here, the followings show conditions under which the virtual object determination unit 33 determines the virtual object VO in the case where the first signal waveform S1 and the second signal waveform S2, which arrive with a time difference, are detected.

The first condition is that the distance of the object indicated by the second signal waveform S2 is substantially N times the distance of the object indicated by the first signal waveform S1. The relationship of the distance being N times indicates the possibility that the second signal waveform S2 is caused by multiple reflections. Here, N may be an integer of 2 or more. On the other hand, it may be configured such that only the case where N=2, that is, only the distance twice as long, is determined.

The second condition is that the amplitude of the first signal waveform S1 indicates a value equal to or greater than a preset amplitude threshold. The amplitude of the signal waveform referred to here is the width defined in time domain or the distance domain. The amplitude refers to the width of the signal waveform, which is the threshold intensity obtained by multiplying the peak intensity PI of the signal waveform by a predetermined coefficient. The predetermined coefficient may be set as appropriate. When the coefficient is 0.5, the amplitude W1 can be said to be the half-width.

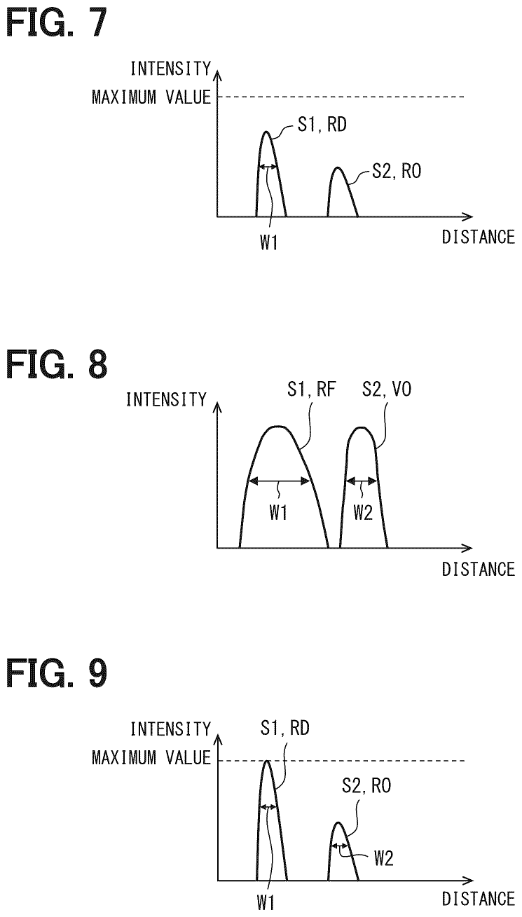

As shown in FIG. 6, when the reflector RF that is likely to cause the detection of the virtual object VO is present, the amplitude of the first signal waveform S1 corresponding to the reflector RF becomes relatively large. On the other hand, as shown in FIG. 7, when the object RO is present behind the raindrop RD, the amplitude of the first signal waveform S1 corresponding to the raindrop RD becomes relatively small. Accordingly, when the amplitude W1 of the first signal waveform S1 is equal to or greater than the amplitude threshold, it indicates the possibility that the object indicated by the first signal waveform S1 is the reflector RF that is likely to cause the generation of the virtual object VO. The amplitude threshold should be set to a value that can distinguish between the reflector RF and the raindrop RD. Additionally, the amplitude threshold may be appropriately adjusted according to the climate or environment of the region where the vehicle is used (for example, in regions prone to sudden heavy rain).

The third condition is that the difference between the amplitude W1 of the first signal waveform S1 and the amplitude W2 of the second signal waveform S2 is equal to or greater than a preset difference threshold. The difference between the amplitude W1 of the first signal waveform S1 and the amplitude W2 of the second signal waveform S2 is the value obtained by subtracting the amplitude W2 of the second signal waveform S2 from the amplitude W1 of the first signal waveform S1.

As shown in FIG. 8, when the first signal waveform S1 corresponds to the reflector RF and the second signal waveform S2 corresponds to the virtual object VO, the amplitude W1 of the first signal waveform S1 becomes greater than the amplitude W2 of the second signal waveform S2. On the other hand, as shown in FIG. 9, when the first signal waveform S1 corresponds to the raindrop RD and the second signal waveform S2 corresponds to the object RO, the difference between the amplitude W1 of the first signal waveform S1 and the amplitude W2 of the second signal waveform S2 tends to be smaller.

Here, in a case where, hypothetically, no lower limit is set for the difference in the third condition and it is simply required that the amplitude W1 of the first signal waveform S1 is greater than the amplitude W2 of the second signal waveform S2, the condition could be satisfied by chance even when both the raindrop RD and the object RO are present. Accordingly, by setting the difference threshold as the lower limit of the difference, the possibility that the object indicated by the second signal waveform S2 is the virtual object VO is increased. The difference threshold is a value greater than zero and can be set to an optimal value based on insights obtained from experiments or other methods.

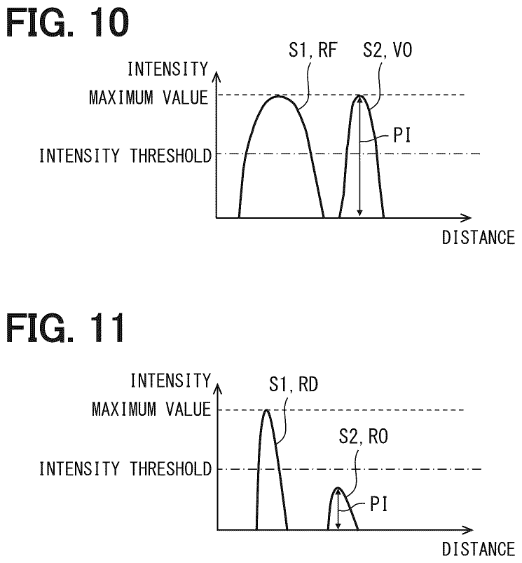

The fourth condition is that the peak intensity PI of the second signal waveform S2 is equal to or greater than the intensity threshold. As shown in FIG. 10, when the second signal waveform S2 indicates multiple reflections from the reflector RF, the peak intensity PI of the second signal waveform S2 becomes relatively high due to the high specular reflectivity of the reflector RF. On the other hand, as shown in FIG. 11, when the first signal waveform S1 corresponds to the raindrop RD and the second signal waveform S2 corresponds to the object RO, the intensity of the light traveling back and forth between the LiDAR 2 and the object RO is attenuated by the raindrop RD. Therefore, the peak intensity PI of the second signal waveform S2 becomes relatively low.

Thus, when the peak intensity PI of the second signal waveform S2 is equal to or greater than the intensity threshold, it indicates the possibility that the second signal waveform S2 is caused by multiple reflections.

The virtual object determination unit 33 may determine that the object corresponding to the second signal waveform S2 is the virtual object VO only when all of the above first to fourth conditions are satisfied. On the other hand, the virtual object determination unit 33 may determine that the object corresponding to the second signal waveform S2 is the virtual object VO when one, two, or three or more of the above first to fourth conditions are satisfied. The virtual object determination unit 33 may comprehensively determine the virtual object VO based on the success or failure of each condition and the respective values used for each condition.

The virtual object determination unit 33 removes the information of the virtual object VO when it determines that there is no object at the distance calculated by the distance calculation unit 32, i.e., when it determines the presence of the virtual object VO. The virtual object determination unit 33 may consider all candidates for objects detected beyond the virtual object VO as noise and remove them when determining that the second signal waveform S2 is the virtual object VO because the distance of the object indicated by the second signal waveform S2 is N times the distance of the object indicated by the first signal waveform S1. Here, the candidates for objects detected beyond the virtual object VO refer to the candidates for objects detected at a distance greater than the virtual object VO with reference to the LiDAR 2. In addition to the virtual object VO at N times the distance, noise can also occur at points that are not at N times the distance due to unnecessary emissions or reflections from objects behind the sensor, and these will be removed. Alternatively, the virtual object determination unit 33 may add information indicating that the object corresponding to the second signal waveform S2 is the virtual object VO, instead of removing the information of the virtual object VO.

The information of objects detected by the processing unit 3 may thus be output and provided to external systems such as the vehicle driving assist system, automated driving system, HMI, and the like.

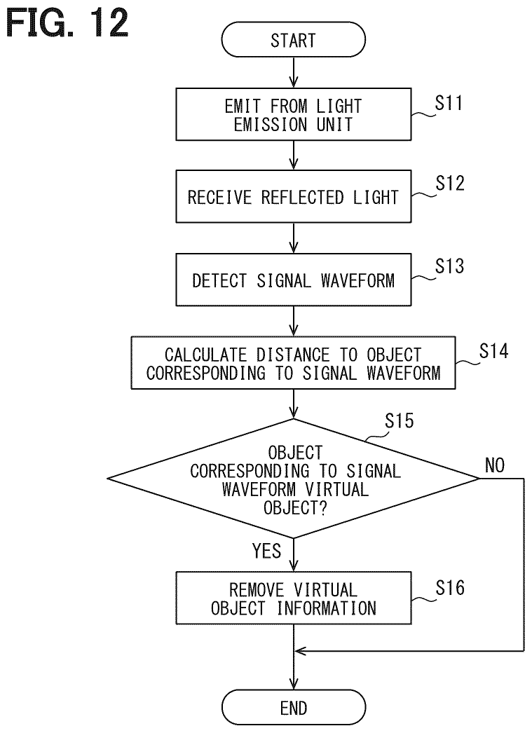

Next, an example of the processing for the virtual object VO in the object detection method by the LiDAR module 1 will be described with reference to the flowchart in FIG. 12. The series of processes shown in S11 to S16 are executed primarily by at least one processor 3b, either at a predetermined execution cycle or based on a predetermined trigger.

In S11, the light emission unit 10 in the LiDAR 2 emits light. After S11, the process proceeds to S12.

In S12, the light reception unit 20 receives the reflection light RL that is reflected from an object in the measurement area MA. After S12, the process proceeds to S13.

In S13, the histogram generation unit 31 in the processing unit 3 acquires information from the light reception unit 20. The histogram generation unit 31 detects the signal waveform of the reflection light RL by generating a histogram. Here, detection includes detecting multiple signal waveforms with peak intensities PI at different positions in the histogram, that is, detecting multiple signal waveforms S1 and S2 that arrive with a time difference. After S13, the process proceeds to S14.

In S14, the distance calculation unit 32 calculates the distance to the object corresponding to the signal waveform. The distance calculation unit 32 calculates the distance to the object corresponding to each signal waveform individually when multiple signal waveforms are detected. After S14, the process proceeds to S15.

In S15, the virtual object determination unit 33 determines whether the object corresponding to the signal waveform is the virtual object VO. When an affirmative determination is made in S15, the process proceeds to S16. When a negative determination is made in S15, the series of processes ends.

In S16, the virtual object determination unit 33 removes the information of the virtual object VO determined in S15. The series of processes ends upon completion of S16.

According to the first embodiment described above, whether the object indicated by the signal waveforms S1 and S2 is the virtual object VO is determined based on the magnitude relationship between the wave amplitudes W1 and W2 of the signal waveforms S1 and S2. Therefore, the determination remains valid even in cases where the peak intensity PI of the signal waveform is saturated. Therefore, it is possible to improve the versatility of determining the virtual object VO.

Additionally, according to the first embodiment, the determination condition includes that the distance of the object indicated by the second signal waveform S2 is substantially N times the distance of the object indicated by the first signal waveform S1. The relationship of the distance being N times suggests the possibility that the second signal waveform S2 is caused by multiple reflections. This enhances the accuracy of determining virtual objects VO resulting from multiple reflections.

Here, the reflector RF tends to easily generate the virtual object VO, and the wave amplitude W1 of the first signal waveform S1 corresponding to the reflector RF tends to be relatively large. In contrast, according to the first embodiment, the determination condition includes that the wave amplitude W1 of the first signal waveform S1 is equal to or greater than a preset wave amplitude threshold. Therefore, it is possible to improve the accuracy of determining the virtual object VO.

Here, when the first signal waveform S1 corresponds to the raindrop RD and the second signal waveform S2 corresponds to the object RO, the difference tends to be small. In contrast, according to the first embodiment, the determination condition includes that the difference between the wave amplitude W1 of the first signal waveform S1 and the wave amplitude W2 of the second signal waveform S2 is equal to or greater than a preset difference threshold. In other words, since the patterns caused by the raindrop RD and the object RO can be distinguished, it is possible to improve the accuracy of determining the virtual object VO.

Here, when the second signal waveform S2 indicates multiple reflections from the reflector RF, the peak intensity PI of the second signal waveform S2 becomes relatively high due to the high specular reflectivity of the reflector RF. In contrast, according to the first embodiment, the determination condition includes that the peak intensity PI of the second signal waveform S2 is equal to or greater than an intensity threshold. Therefore, it is possible to improve the accuracy of determining virtual objects VO caused by multiple reflections.

In the first embodiment, the LiDAR 2 corresponds to a “sensor”. The processing unit 3 corresponds to an “object detection device”. The histogram generation unit 31 corresponds to a “waveform detection unit”.

### Second Embodiment

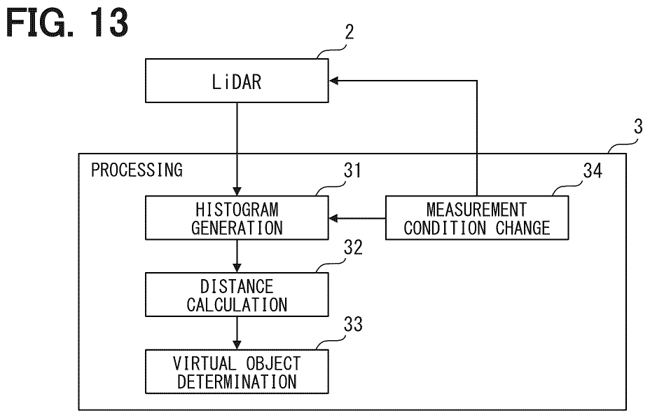

As shown in FIGS. 13 to 15, the second embodiment is a modification of the first embodiment. The second embodiment will be described focusing on the differences from the first embodiment.

As shown in FIG. 13, the processing unit 3 of the second embodiment includes a measurement condition changing unit 34, which is implemented as a functional block executed by at least one processor 3b executing the program.

The measurement condition changing unit 34 changes the measurement condition based on a predetermined trigger. The predetermined trigger may be detection of multiple signal waveforms S1 and S2 arriving with a time difference by the histogram generation unit 31. Further, the predetermined trigger may be that multiple signal waveforms are detected, and the intensities of the first signal waveform S1 and the second signal waveform S2 are saturated. Furthermore, the predetermined trigger may be that multiple signal waveforms are detected, and the intensity of the first signal waveform S1 is saturated.

Additionally, the measurement condition changing unit 34 may change the measurement condition for each generation of the histogram (in other words, for each frame). For example, the first measurement condition and the second measurement condition may be set in advance, and the measurement condition changing unit 34 may alternately set the first measurement condition and the second measurement condition.

As for the change in measurement conditions, it is preferable that at least one of the following specific changes is implemented. Among the measurement conditions listed below, only one type may be changed, or two or more types may be changed simultaneously.

As the change in measurement conditions, the measurement condition changing unit 34 may reduce the emission intensity of the light emission unit 10 to an intensity weaker than the emission intensity of the light emission unit 10 before detecting the trigger.

As the change in measurement conditions, the measurement condition changing unit 34 may reduce the number of sampling integrations to be fewer than the number of sampling integrations before detecting the trigger.

As the change in measurement conditions, the measurement condition changing unit 34 may change at least one of the position and the size of the ROI with respect to the ROI at the time the trigger is detected.

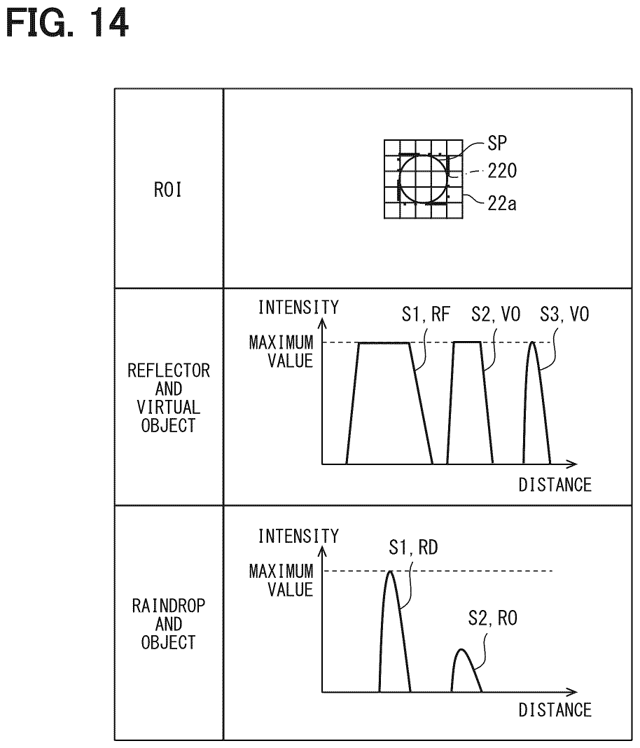

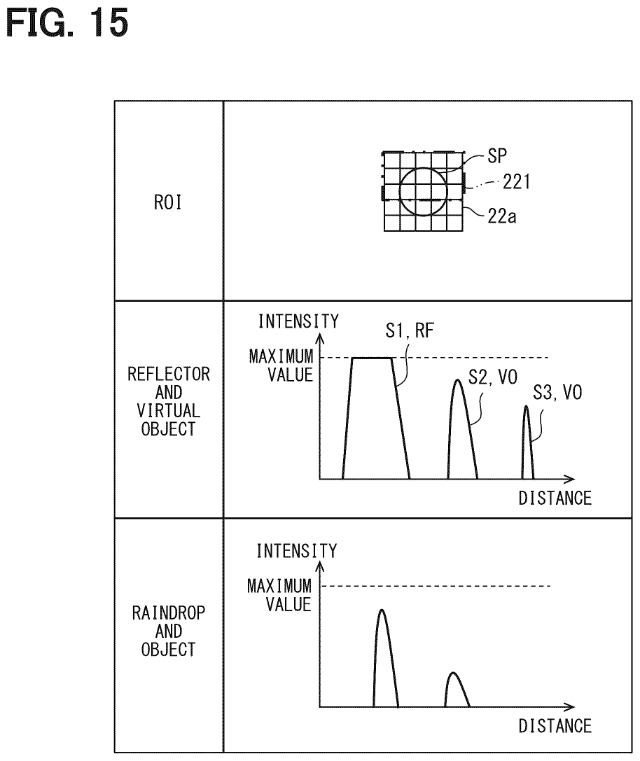

FIGS. 14 and 15 illustrate examples of changing the ROI. FIG. 14 shows a ROI 220 before the change and the corresponding signal waveforms S1, S2, and S3. The ROI 220 shown in the upper part of FIG. 14 corresponds to the region (light reception spot SP) on the light reception element 22 where the light receiving beam of the reflection light RL is incident. A graph shown in the middle part of FIG. 14 indicates a case where, with respect to the ROI 220 in the upper part, the first signal waveform S1 corresponds to the reflector RF, and the second signal waveform S2 and the third signal waveform S3 correspond to the virtual object VO. A graph shown in the lower part of FIG. 14 illustrates a case where, with respect to the ROI 220 in the upper part, the first signal waveform S1 corresponds to the raindrop RD, and the second signal waveform S2 corresponds to the object RO.

FIG. 15 shows a ROI 221 after the change and the corresponding signal waveforms S1, S2, and S3. The ROI 221 shown in the upper part of FIG. 15 is displaced from the light reception spot SP on the light reception element 22 and is enlarged in size compared to before the change. In other words, the ROI 221 after the change is set in a region where the intensity is less likely to become saturated compared to the ROI 220 before the change.

A graph shown in the middle part of FIG. 15 illustrates a case where, with respect to the ROI 221 in the upper part, the first signal waveform S1 corresponds to the reflector RF, and the second signal waveform S2 and the third signal waveform S3 correspond to the virtual object VO. A graph shown in the lower part of FIG. 15 illustrates a case where, with respect to the ROI 221 in the upper part, the first signal waveform S1 corresponds to the raindrop RD, and the second signal waveform S2 corresponds to the object RO.

According to the comparison of FIGS. 14 and 15, when the first signal waveform S1 corresponds to the raindrop RD, changing the ROI causes the tendency of more easily avoiding the intensity saturation. On the other hand, when the first signal waveform S1 corresponds to the reflector RF, the intensity saturation tends to be difficult to be avoided even with the change of the ROI. The virtual object determination unit 33 can utilize this difference in tendencies to determine that the second signal waveform S2 and the third signal waveform S3 correspond to the virtual object VO.

According to the second embodiment described above, the measurement conditions of the reflection light RL are changed to cause changes in the intensity saturation state of the signal waveforms S1, S2, and S3 corresponding to the type of object. By confirming the response of the signal waveforms S1, S2, and S3 before and after changing the measurement conditions, in other words, the changes in the saturation state, it is possible to significantly improve the determination accuracy of the virtual object VO.

Here, the type of object may be classified based on differences in reflective characteristics, such as those of the reflector RF or raindrops RD.

### Third Embodiment

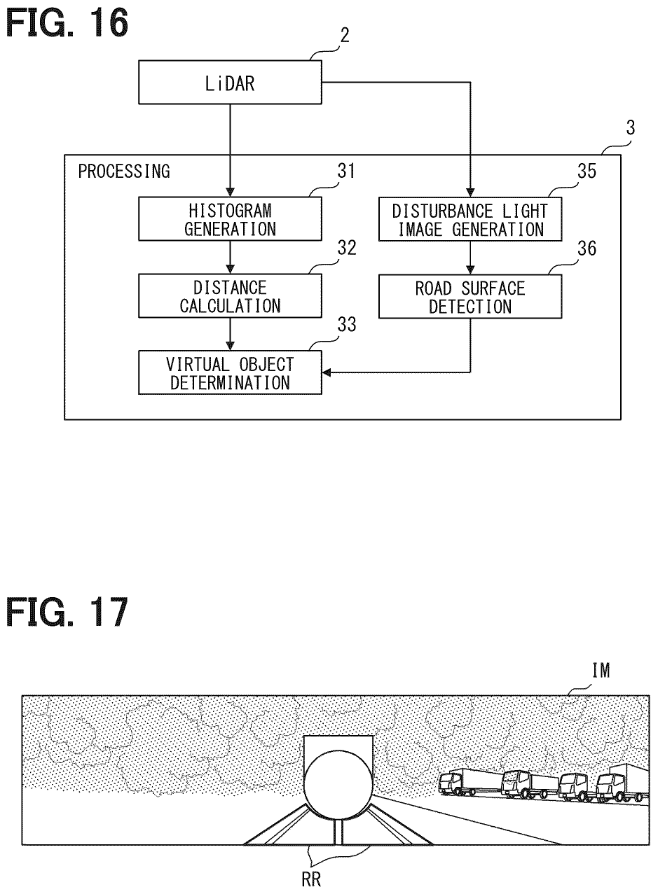

As shown in FIGS. 16 and 17, a third embodiment is a modification of the first embodiment. The third embodiment will be described mainly focusing on the differences from the first embodiment.

The processing unit 3 of the second embodiment, as shown in FIG. 16, includes a disturbance light image generation unit 35 and a road surface detection unit 36 as functional blocks implemented by at least one processor 3b executing a program.

The disturbance light image generation unit 35 generates a disturbance light image IM based on the sampling results from the light reception element 22 when the light emission unit 10 is not emitting light. The disturbance light image IM shown in FIG. 17 is an image that does not include reflection light RL and visualizes the intensity of the disturbance light received by the light reception element 22. The disturbance light image IM is also referred to as a background light image.

The road surface detection unit 36 processes the disturbance light image IM and detects a road surface RR captured in the disturbance light image IM. The road surface detection unit 36 may extract the region occupied by the road surface RR within the disturbance light image IM. The detection of the road surface RR may be performed using preset conditions for distinguishing the road surface RR. The detection of the road surface RR may be performed using a trained road surface detection model that includes a neural network.

The virtual object determination unit 33 of the third embodiment determines the virtual object VO by referring to the detection results of the road surface detection unit 36. Specifically, even in a case where the virtual object determination unit 33 detects another signal waveform S2, which corresponds to a distance substantially N times the distance of the object indicated by the first signal waveform S1, as a candidate for the virtual object VO, it determines that this other signal waveform S2 does not indicate the virtual object VO when the road surface RR has been detected at the N times distance. That is, the virtual object determination unit 33 determines that it is not the virtual object VO even when the first condition indicated in the first embodiment is satisfied.

According to the third embodiment described above, when the distance of the object indicated by the second signal waveform S2 is substantially N times the distance of the object indicated by the first signal waveform S1, and the road surface RR present at the N times distance is detected, the object indicated by the second signal waveform S2 is determined not to be the virtual object VO. By utilizing the detection results of the road surface RR, it is possible to improve the determination accuracy of the virtual object VO.

### Fourth Embodiment

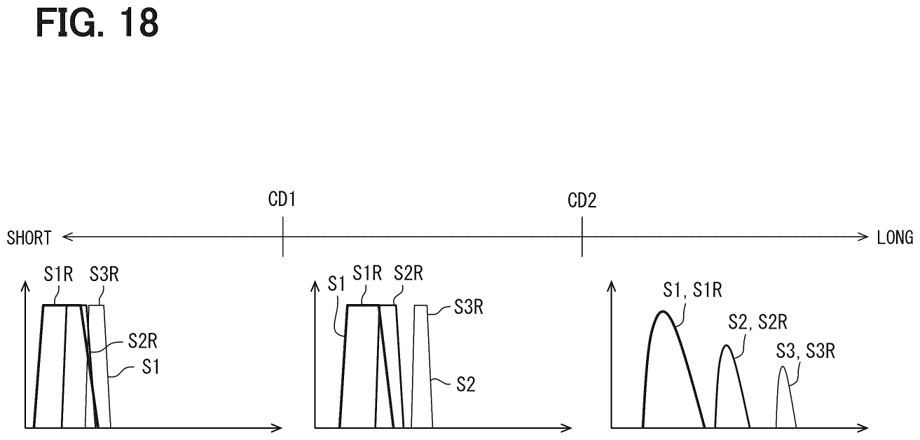

As shown in FIG. 18, a fourth embodiment is a modification of the first embodiment. The fourth embodiment will be described, focusing on the differences from the first embodiment.

In the fourth embodiment, the configuration improves the determination accuracy when signal waveforms S2R and S3R corresponding to the virtual object VO overlap with a signal waveform S1R corresponding to the reflector RF.

As shown in FIG. 18, the overlapping state of the signal waveforms S2R and S3R, which include the virtual object VO, changes depending on the distance at which the reflector RF is located. For example, when the distance at which the reflector RF is located is smaller than CD1, that is, in the “very short distance”, the signal waveforms S2R and S3R due to multiple reflections overlap with the signal waveform S1R due to a single reflection. More specifically, as the distance at which the reflector RF is located becomes close to twice and three times the distance, the signal waveform S2R due to double round-trip reflection and the signal waveform S3R due to triple round-trip reflection overlap within the range of the waveform indicated by the signal waveform S1R due to the single reflection. In other words, the signal waveforms S1R, S2R, and S3R can be detected as a single consolidated signal waveform S1. The term “very short distance” refers to a distance, for example, smaller than 1.5 meters.

However, in this case, the signal waveform S2R due to double round-trip reflection and the signal waveform S3R due to triple round-trip reflection are not erroneously detected as objects independent of the reflector RF. Therefore, issues related to the determination of the virtual object VO do not occur.

When the distance to the reflector RF is greater than CD2, that is, in the case of “medium to long distance”, the signal waveform S1R due to single reflection, the signal waveform S2R due to double round-trip reflection, and the signal waveform S3R due to triple round-trip reflection are separated from each other. It is assumed that CD2 has a greater value than CD1. Furthermore, the “medium to long distance” is assumed to be a distance greater than, for example, 3.0 meters.

In the case of this “medium to long distance”, the virtual object VO can be determined under the same conditions as in the first embodiment. In more details, under the first condition, it should be determined that the distance of the object indicated by the second signal waveform S2 is substantially twice the distance of the object indicated by the first signal waveform S1. The third signal waveform S3, corresponding to a distance that is three times or more, should be handled in accordance with the determination results for the second signal waveform S2, which corresponds to twice the distance.

When the distance where the reflector RF exists is greater than CD1 and smaller than CD2, that is, when the distance is “close”, the signal waveform S3R due to the three round trip reflections is separated. However, the signal waveform S1R due to one reflection and the signal waveform S2R due to two round-trip reflections overlap each other. In other words, the signal waveforms S1R and S2R are detected as a single combined first signal waveform S1, and the signal waveform S3R can be detected as the second signal waveform S2. It should be noted that “short distance” is assumed to be in the range of, for example, 1.5 to 3.0 meters.

In the case of this “short distance”, even when the independent signal waveform does not exist at twice the distance, and when the independent signal waveform S2 exists at three times the distance, the second signal waveform S2 could be detected as an object independent of the reflector RF.

Therefore, in the fourth embodiment, the virtual object determination unit 33 determines that the distance of the object indicated by the second signal waveform S2 is substantially three times the distance of the object indicated by the first signal waveform S1 when the distance of the object indicated by the first signal waveform S1 is within a preset distance range. This distance range corresponds to the “short distance”. The distance range can be set, for example, based on findings obtained from experiments or the like, to correspond to a range from CD1 to CD2 in FIG. 18. When the second signal waveform S2 indicates a distance three times greater, the virtual object determination unit 33 determines that the object corresponding to the second signal waveform S2 is the virtual object VO in combination with other conditions shown in the first embodiment.

According to the fourth embodiment described above, when the distance indicated by the first signal waveform S1 is within a predetermined distance range (corresponding to a “short distance”), the condition that the distance of the object indicated by the second signal waveform S2 is substantially three times the distance of the object indicated by the first signal waveform S1 is included in the determination condition. In other words, within the distance range corresponding to the “short distance”, even in a case where a signal corresponding to twice the distance is not confirmed, when a signal corresponding to three times the distance is confirmed, it is determined to be the virtual object. In other words, it is possible to prevent the virtual object VO from being erroneously detected as a real object.

### Other Embodiments

As described above, multiple embodiments have been described, but the present disclosure is not to be interpreted as being limited to these embodiments. Various modifications and combinations can be applied within the scope that does not deviate from the gist of the present disclosure.

Specifically, the main unit of the LiDAR 2 and the processing unit 3 may be placed at different positions within the vehicle and may be communicatively connected to each other via wired or wireless communication using the in-vehicle network. The processing unit 3 may be incorporated as part of, for example, an ADAS domain controller or an automated driving system, and it may be shared with this hardware.

The virtual object determination unit 33 may perform the determination described in each embodiment and remove the information of the virtual object VO when the intensity of the first signal waveform S1 and the intensity of the second signal waveform S2 are saturated.

In the third embodiment, the road surface detection unit 36 may detect the road surface RR using the point cloud measured by the LiDAR 2 instead of the disturbance light image IM. The road surface detection unit 36 may detect the road surface RR from the image of the onboard camera instead of the disturbance light image IM. The road surface detection unit 36 may simply acquire the detection results of the road surface RR detected by other processing devices of the vehicle.

The controller and its method described in the present disclosure may be implemented by a dedicated computer that constitutes a processor programmed to execute one or more functions embodied by a computer program. Alternatively, the device and its methods described in the present disclosure may be implemented by dedicated hardware logic circuits. Alternatively, the devices and its methods described in the present disclosure may be implemented by one or more dedicated computers constituted by a combination of a processor executing a computer program and one or more hardware logic circuits. Additionally, the computer program may be stored on a computer-readable non-transitory tangible recording medium as instructions executed by a computer.

What is claimed is:

1. An object detection device configured to detect an object based on information acquired from a sensor that irradiates, with irradiation light, a measurement area and detects reflection light from the object in the measurement area, the device comprising:
a waveform detection unit configured to detect a plurality of signal waveforms of the reflection light, wherein the plurality of signal waveforms reach the sensor with a time difference; and
a virtual object determination unit configured to determine whether the object indicated by the plurality of signal waveforms is a virtual object based on a magnitude relationship of a plurality of waveform widths of the plurality of signal waveforms.

2. The object detection device according to claim 1, wherein
the plurality of signal waveforms include a first signal waveform and a second signal waveform that arrives after the first signal waveform,
N is defined as an integer of 2 or more, and
the virtual object determination unit uses a determination condition that a distance of the object indicated by the second signal waveform is N times a distance of the object indicated by the first signal waveform.

3. The object detection device according to claim 2, wherein
when determining that the second signal waveform is the virtual object due to a state where the distance of the object indicated by the second signal waveform indicates the distance being N times the distance of the object indicated by the first signal waveform, the virtual object determination unit determines all object candidates detected beyond the virtual object as noise and removes the noise.

4. The object detection device according to claim 1, wherein
the plurality of signal waveforms include a first signal waveform and a second signal waveform arriving after the first signal waveform, and
the virtual object determination unit is configured to use a determination condition that a waveform width of the first signal waveform is equal to or greater than a preset waveform width threshold value.

5. The object detection device according to claim 1, wherein
the plurality of signal waveforms include a first signal waveform and a second signal waveform arriving after the first signal waveform, and
the virtual object determination unit uses a determination condition that a difference between a waveform width of the first signal waveform and a waveform width of the second signal waveform is equal to or greater than a preset difference threshold.

6. The object detection device according to claim 1, wherein
the plurality of signal waveforms include a first signal waveform and a second signal waveform arriving after the first signal waveform, and
the virtual object determination unit uses a determination condition that a peak intensity of the second signal waveform is equal to or greater than an intensity threshold.

7. The object detection device according to claim 1, further comprising
a measurement condition changing unit configured to change a measurement condition of the reflection light to avoid saturation of a signal waveform intensity according to a type of the object.

8. The object detection device according to claim 7, wherein
the signal waveform intensity is obtained based on the reflection light detected in a region-of-interest of a pixel of the sensor, and
when changing the measurement condition, the measurement condition changing unit changes a size of the region-of-interest.

9. The object detection device according to claim 7, wherein
the signal waveform intensity is obtained based on the reflection light detected in a region-of-interest of a pixel of the sensor, and
when changing the measurement condition, the measurement condition changing unit changes a position of the region-of-interest.

10. The object detection device according to claim 7, wherein
when changing the measurement condition, the measurement condition changing unit sets an irradiation intensity of the irradiation light emitted from the sensor to a weaker intensity than before changing the measurement condition.

11. The object detection device according to claim 1, further comprising
a road surface detection unit configured to detect a road surface based on information from the sensor,
wherein
the virtual object determination unit is configured to use a determination condition of determining that a candidate of the virtual object is not the virtual object when a candidate position of the virtual object is included in a position of the road surface.

12. The object detection device according to claim 11, wherein
the road surface detection unit is configured to detect the road surface using disturbance light.

13. The object detection device according to claim 11, wherein
the road surface detection unit detects a road surface using a point cloud measured by the sensor.

14. The object detection device according to claim 11, wherein
the plurality of signal waveforms include a first signal waveform and a second signal waveform arriving after the first signal waveform,
N is defined as an integer of 2 or more, and
the virtual object determination unit uses a determination condition of determining that the object indicated by the second signal waveform is not the virtual object when a distance of the object indicated by the second signal waveform is substantially N times a distance of the object indicated by the first signal waveform and the road surface is present at the N times distance.

15. The object detection device according to claim 1, wherein
the plurality of signal waveforms include a first signal waveform and a second signal waveform arriving next to the first signal waveform, and
the virtual object determination unit uses a determination condition of determining that an object indicated by the second signal waveform is the virtual object,
when a distance of an object indicated by the first signal waveform is substantially three times a distance of an object indicated by the second signal waveform,
in a case where a candidate of the virtual object is not detected at a distance being twice the distance of the object indicated by the first signal waveform and also the distance indicated by the first signal waveform is within a preset distance range.

16. An object detection method executed by at least one processor for detecting an object, the method comprising:
irradiating light toward a measurement area using a sensor;
detecting reflection light from an object in the measurement area using the sensor;
detecting a plurality of signal waveforms of the reflection light, wherein the plurality of signal waveforms reach the sensor with a time difference; and
determining whether the object indicated by the plurality of signal waveforms is a virtual object based on a magnitude relationship of a plurality of waveform widths of the plurality of signal waveforms.
